(19) United States
(12) Patent Application Publication
(10) Pub. No.: US 2019/0221193 A1
(43) Pub. Date: Jul. 18, 2019

(54) System And Method Of Updating One Or More Images

(71) Applicant: Dell Products L.P., Round Rock, TX (US)

(72) Inventor: Lawrence E. Knepper, Leander, TX (US)

(21) Appl. No.: 15/874,679

(22) Filed: Jan. 18, 2018

(51) Int. Cl. G09G 5/395; G06T 1/20; G09G 5/37

(52) U.S. Cl. CPC G09G 5/395; G09G 2320/0252; G09G 5/37; G06T 1/20

(57) ABSTRACT

In one or more embodiments, a graphics processing unit may receive data from one or more sensors of a head mounted display; may determine one or more of a translation, a rotation, and an acceleration from the data from the one or more sensors of the head mounted display; may modify a geometry of a scene for a next image frame based at least on the one or more of the translation, the rotation, and the acceleration; and may provide the next image frame to a display of the head mounted device. In one or more embodiments, the graphics processing unit may include a first set of cores that may execute an application that modifies the geometry of the scene for the next image frame and may include a second set of cores that may execute other instructions.

### BACKGROUND

### Field of the Disclosure

This disclosure relates generally to information handling systems and more particularly to graphics processing units.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, methods, and/or processes may provide images of an application to a head mounted display and may receive data from one or more sensors of the head mounted display. For example, a graphic processing unit may receive the data from the one or more sensors of the head mounted display. For instance, the graphic processing unit may receive the data from the one or more sensors of the head mounted display without the data being communicated via at least one central processing unit of an information handling system. In one or more embodiments, a sensor hub may provide the data from the one or more sensors of the head mounted display to the graphic processing unit, rather than a processor (e.g., a central processing unit) providing the data from the one or more sensors of the head mounted display to the graphic processing unit. For example, the one or more sensors may be coupled to the sensor hub. In one instance, an information handling system may include the sensor hub. In another instance, the head mounted display may include the sensor hub. In one or more embodiments, the sensor hub may receive raw sensor data from the one or more sensors of the head mounted display, may process the raw sensor data from the one or more sensors of the head mounted display to produce the data from the one or more sensors of the head mounted display, and may provide the data from the one or more sensors of the head mounted display to the graphics processing unit. In one example, the sensor hub may convert the raw sensor data of a first protocol into a second protocol. In another example, the sensor hub may aggregate the raw sensor data and may provide aggregated data to the graphics processing unit.

In one or more embodiments, the graphic processing unit may determine one or more of a translation, a rotation, and an acceleration from the data from the one or more sensors of the head mounted display, may modify a geometry of a scene for a next image frame based at least on the one or more of the translation, the rotation, and the acceleration, and may provide the next image frame to a display of the head mounted device. In one or more embodiments, the graphics processing unit may include multiple graphics processing unit cores. In one example, a first graphics processing unit core of the graphics processing unit may modify the geometry of the scene for the next image frame based at least on the one or more of the translation, the rotation, and the acceleration, and a second graphics processing unit core of the graphics processing unit, different from the first graphics processing unit core, may provide the next image frame to the display of the head mounted device. In a second example, two or more graphics processing unit cores of a first set of the multiple graphics processing unit cores may execute an application that modifies the geometry of the scene for the next image frame based at least on the one or more of the translation, the rotation, and the acceleration. In another example, two or more graphics processing unit cores of a second set of the multiple graphics processing unit cores, different from the first set of graphics processing unit cores, may execute instructions different from the application that modifies the geometry of the scene for the next image frame based at least on the one or more of the translation, the rotation, and the acceleration. For instance, the two or more graphics processing unit cores of the first set of the multiple graphics processing unit cores may execute the application in parallel with the second set of the multiple graphics processing unit cores executing the other instructions, different from the application.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2 illustrates an example of a sensor hub, according to one or more embodiments;

FIGS. 3A and 3B illustrate examples of a head mounted display, according to one or more embodiments;

FIG. 3C illustrates an example of a head mounted display coupled to an information handling system, according to one or more embodiments;

FIGS. 3D and 3E illustrate other examples of a head mounted display coupled to an information handling system, according to one or more embodiments;

FIG. 3F illustrates an example of a head mounted display that includes an information handling system, according to one or more embodiments;

FIG. 3G illustrates an example of a user wearing a head mounted display, according to one or more embodiments;

FIGS. 3H and 3I illustrate examples of a head mounted display at different angles with respect to different axes, according to one or more embodiments;

FIG. 4 illustrates a block diagram of operating multiple GPU cores, according to one or more embodiments; and

FIG. 5 illustrates an example of a method of operating a system, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a head mounted device (HMD) may be utilized with one or more virtual reality (VR) applications, one or more augmented reality (AR) applications, and/or one or more mixed reality (MR) applications, among others. For example, the HMD may include sensors (e.g., an electronic accelerometer, an electronic gyroscope, an electronic magnetometer, etc.) that may determine movement of the HMD and may provide sensor data to an information handling system for processing. In one or more embodiments, the information handling system may process the sensor data from the HMD and may update one or more images for display to a user of the HMD. For example, various elements of the information handling system may handle and/or may process the sensor data. In one or more embodiments, providing the sensor data to a graphics processing unit (GPU) may increase performance in updating one or more images for display to the user of the HMD. For example, a latency of first providing the sensor data to a central processing unit (CPU) and then updating one or more images for display to the user of the HMD may be mitigated or eliminated.

In one or more embodiments, a GPU may be or include a general purpose GPU (GPGPU). For example, the GPU may include multiple GPGPU cores. For instance, the multiple GPGPU cores may process data in a parallel fashion. In one or more embodiments, the GPU may receive sensor data from a HMD, may process the sensor data, and may update one or more images based at least on the sensor data from the HMD. For example, the GPU may receive sensor data from the HMD rather than a CPU receiving the sensor data, processing the sensor data, and directing the GPU to update one or more images based at least on the sensor data from the HMD that the CPU received. For instance, multiple GPU cores may receive the sensor data from the HMD and may utilize the sensor data from the HMD to modify one or more scene geometries for a next image frame, and the user of the HMD may view rendered scene movements that correspond to motion of the HMD with minimal latency.

In one or more embodiments, a sensor hub may collect sensor data from the HMD (e.g., translation, rotation, acceleration, etc.), may process the sensor data from the HMD, and may provide processed sensor data to a GPU. For example, the sensor hub may be coupled to the GPU, rather than being coupled to a CPU of an information handling system. In one or more embodiments, an application executing on a subset N of M cores of the GPU may receive the processed sensor data and may utilize the processed sensor data to modify scene geometry for a next image frame for display via the HMD. For example, latency that a user may observe may be reduced when the N cores of the GPU receives the processed sensor data from the sensor hub, as opposed to the N cores of the GPU receiving the processed sensor data from the CPU of the information handling system. For instance, this may be advantageous in reducing one or more CPU loads and/or in providing images to the HMD in a more expedient fashion and/or manner. In one or more embodiments, one or more GPU cores processing the sensor data from the HMD may provide one or more advantages. For example, a CPU may not include a multilane graphics port, and since rendering geometry changes are handled by the one or more GPU cores in response to the sensor data from the HMD, a CPU may be bypassed. For instance, the CPU may not factor into a latency path of updating one or more scene geometries for a next image frame.

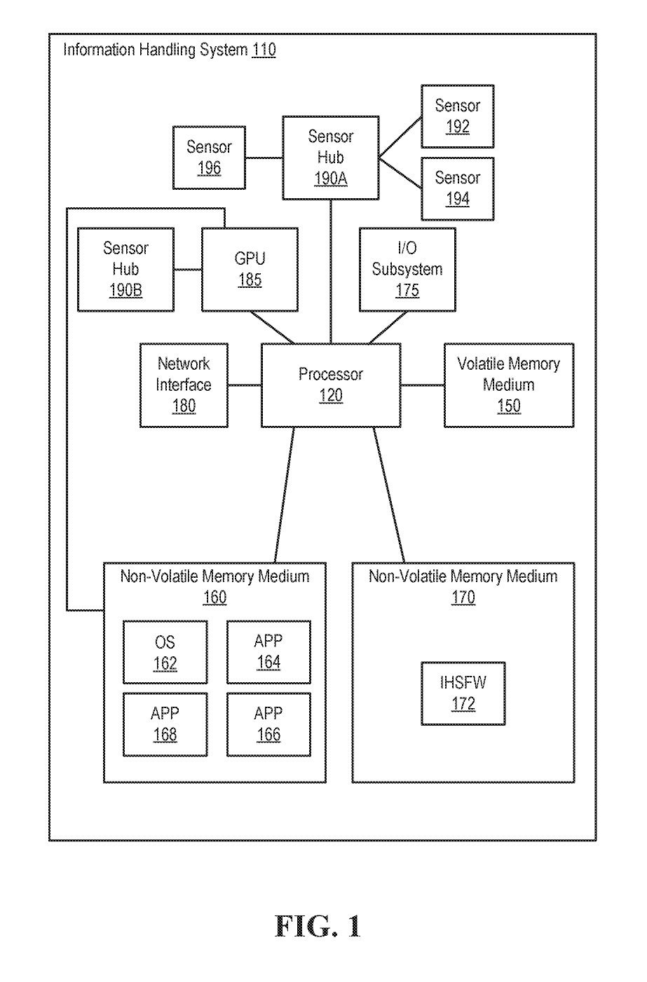

Turning now to FIG. 1, an exemplary information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, a network interface 180, a GPU 185, sensor hubs 190A and 190B, and sensors 192-196. As illustrated, volatile memory medium 150, non-volatile memory media 160 and 170, I/O subsystem 175, network interface 180, GPU 185, and sensor hub 190A may be communicatively coupled to processor 120. As shown, sensor hub 190B and non-volatile memory medium 160 may be communicatively coupled to GPU 185. In one or more embodiments, sensor hub 190 may be included in another element of IHS 110. In one example, although not specifically illustrated, sensor hub 190A may be included in processor 120 or may be included in a system-on-chip (SoC) that includes processor 120. In another example, although not specifically shown, sensor hub 190B may be included in GPU 185 or may be included in a SoC that includes GPU 185.

In one or more embodiments, one or more of volatile memory medium 150, non-volatile memory media 160 and 170, I/O subsystem 175, network interface 180, and GPU 185 may be communicatively coupled to processor 120 via one or more buses, one or more switches, and/or one or more root complexes, among others. In one example, one or more of volatile memory medium 150, non-volatile memory media 160 and 170, I/O subsystem 175, network interface 180, and GPU 185 may be communicatively coupled to processor 120 via one or more PCI-Express (PCIe) root complexes. In another example, one or more of I/O subsystem 175 and network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, GPU 185 may manipulate and/or alter memory to accelerate creation of one or more images in a frame buffer intended for output to a display device. In one example, GPU 185 may be utilized to perform memory-intensive work such as texture mapping and/or rendering polygons. In a second example, GPU 185 may be utilized to perform geometric calculations such as rotations and/or translations of vertices into different coordinate systems. In another example, GPU 185 may perform one or more computations associated with three-dimensional graphics. In one or more embodiments, GPU 185 may be utilized in oversampling and/or interpolation method and/or processes. For example, GPU 185 may be utilized to reduce aliasing.

In one or more embodiments, GPU 185 may include multiple parallel processors. In one example, the multiple parallel processors may be utilized to implement one or more methods and/or processes that involve one or more matrix and/or vector operations, among others. In another example, the multiple parallel processors may be utilized to implement one or more methods and/or processes described herein. In one or more embodiments, GPU 185 may execute GPU processor instructions in implementing one or more systems, flowcharts, methods, and/or processes described herein. In one example, GPU 185 may execute GPU processor instructions from one or more of memory media 150-170 in implementing one or more systems, flowcharts, methods, and/or processes described herein. In another example, GPU 185 may execute GPU processor instructions via network interface 180 in implementing one or more systems, flowcharts, methods, and/or processes described herein.

In one or more embodiments, processor 120 may execute processor instructions in implementing one or more systems, flowcharts, methods, and/or processes described herein. In one example, processor 120 may execute processor instructions from one or more of memory media 150-170 in implementing one or more systems, flowcharts, methods, and/or processes described herein. In another example, processor 120 may execute processor instructions via network interface 180 in implementing one or more systems, flowcharts, methods, and/or processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150. In one or more embodiments, one or more of APPs 164-168 may include one or more respective GPU APPs. For example, GPU 185 may execute one or more of APPs 164-168 in accordance with one or more methods, processes, and/or systems, described herein. For instance, one or more of APPs 164-168 may include GPU processor instructions.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or functionalities of one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, processor 120 and one or more components of IHS 110 may be included in a SoC. For example, the SoC may include processor 120 and a platform controller hub (not specifically illustrated). In one or more embodiments, GPU 185 may be coupled to the platform controller hub.

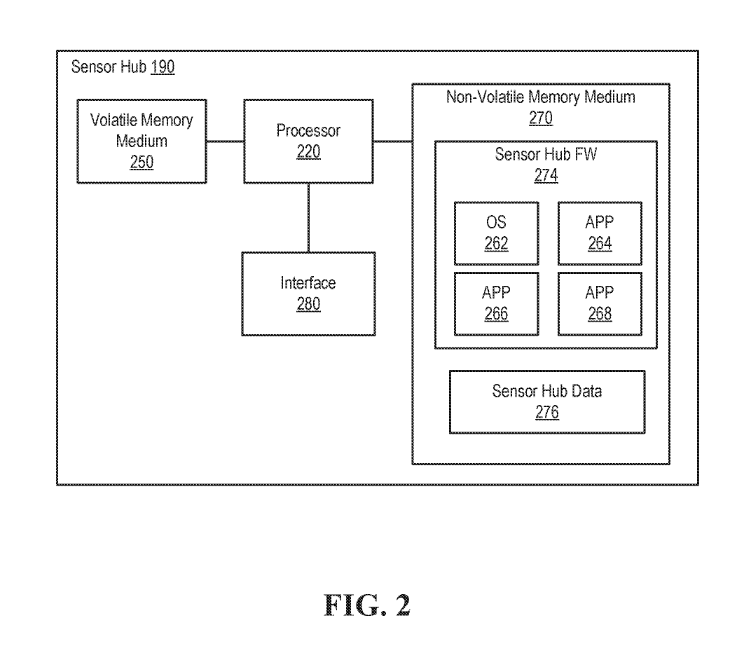

Turning now to FIG. 2, an example of a sensor hub is illustrated, according to one or more embodiments. As shown, sensor hub 190 may include a processor 220, a volatile memory medium 250, a non-volatile memory medium 270, and an interface 280. As illustrated, non-volatile memory medium 270 may include a sensor hub FW 274, which may include an OS 262 and APPs 264-268, and may include sensor hub data 276. For example, OS 262 may be or include a real-time operating system (RTOS).

In one or more embodiments, interface 280 may include circuitry that enables communicatively coupling to one or more devices. In one example, interface 280 may include circuitry that enables sensor hub 190 to communicate with one or more of a processor, a sensor, and a GPU, among others. In a second example, interface 280 may include circuitry that enables communicatively coupling to one or more buses. In another example, interface 280 may include circuitry that enables one or more interrupt signals to be received. For instance, interface 280 may include general purpose input/output (GPIO) circuitry, and the GPIO circuitry may enable one or more interrupt signals to be received and/or provided via at least one interrupt line.

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250.

In one or more embodiments, processor 220 may utilize sensor hub data 276. In one example, processor 220 may utilize sensor hub data 276 via non-volatile memory medium 270. In another example, one or more portions of sensor hub data 276 may be transferred to volatile memory medium 250, and processor 220 may utilize sensor hub data 276 via volatile memory medium 250.

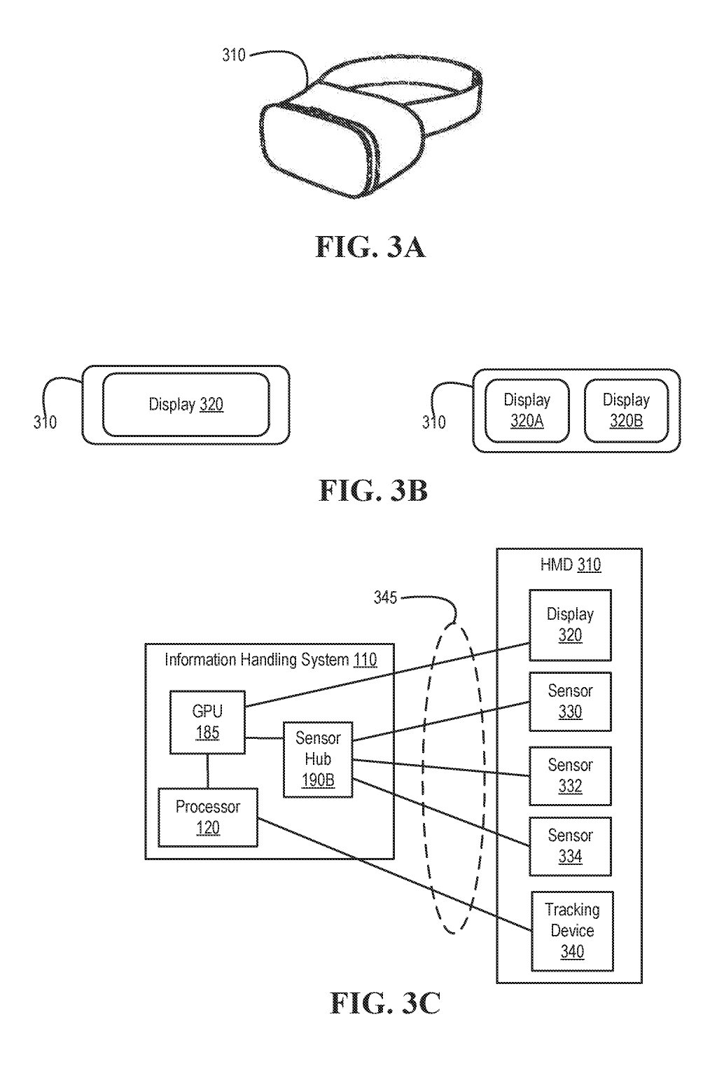

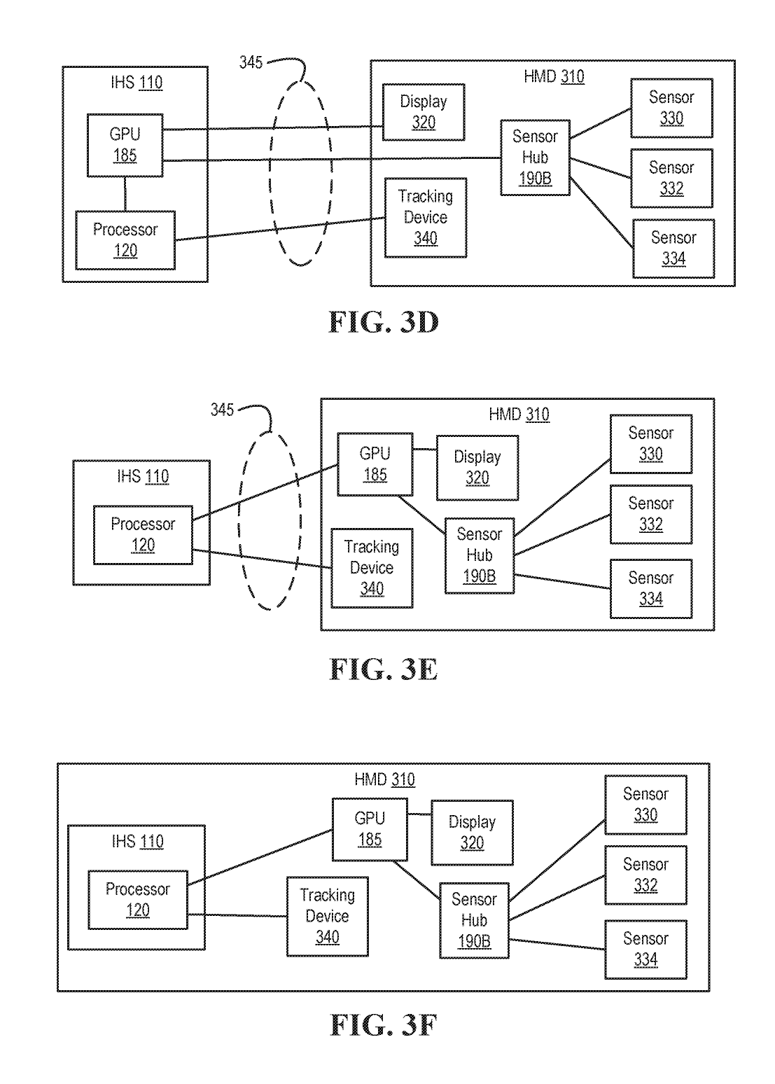

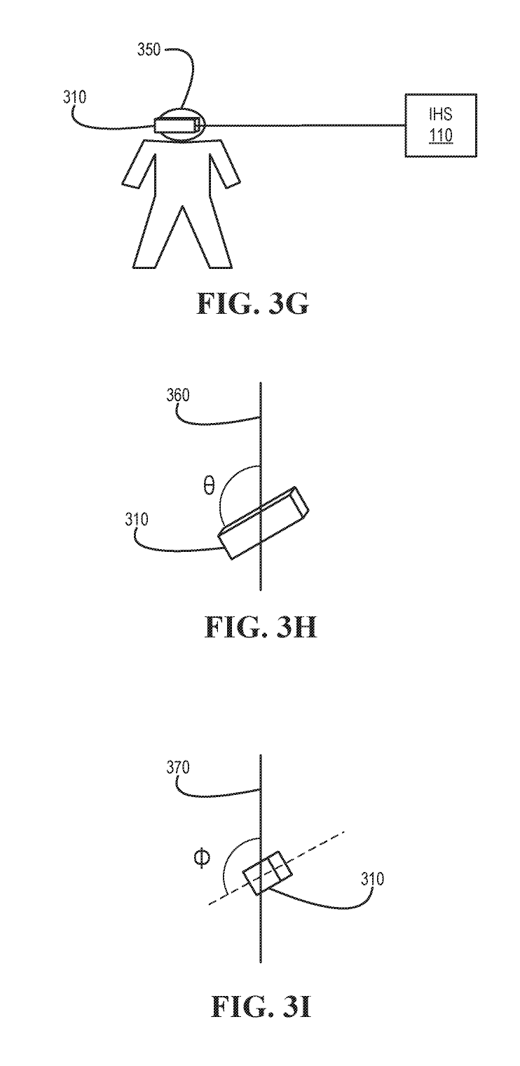

Turning now to FIGS. 3A and 3B, examples of a head mounted display is illustrated, according to one or more embodiments. As shown in FIG. 3A, a HMD 310 may be a wearable device. In one example, HMD 310 may be or include a VR device. In a second example, HMD 310 may be or include an AR device. In another example, HMD 310 may be or include a MR device. As shown in FIG. 3B, HMD 310 may include a single display 320 or may include multiple displays 320A and 320B. Referring to display 320 may refer to a single display or one or more of multiple displays 320A and 320B, according to one or more embodiments. For example, one or more images and/or one or more videos may be provided to a user via display 320.

Turning now to FIG. 3C, an example of a head mounted display coupled to an information handling system is illustrated, according to one or more embodiments. As shown, HMD 310 may include display 320, sensors 330-334, and a tracking device 340. As illustrated, display 320 may be communicatively coupled to GPU 185, sensors 330-334 may be communicatively coupled to sensor hub 190B, and tracking device 340 may be communicatively coupled to processor 120. For example, sensor 330 may be or include an electronic accelerometer (e.g., a multi-axis accelerometer), sensor 332 may be or include an electronic gyroscope, and/or sensor 334 may be or include an electronic magnetometer. For instance, one or more of sensors 330-334 may be or include a MEMS (micro-electro-mechanical) device. In one or more embodiments, a communications cable 345 may be utilized to communicatively couple display 320 to GPU 185, sensors 330-334 to sensor hub 190B, and tracking device 340 to processor 120. For example, cable 345 may include multiple communication media. For instance, cable 345 may include communication media that supports one or more of USB, I²C, SPI, PCIe, HDMI (High-Definition Multimedia Interface), DVI (Digital Visual Interface), etc. In one or more embodiments, tracking device 340 may track eye movements and/or eye positions of a user of HMD 310.

Turning now to FIGS. 3D and 3E, other examples of a head mounted display coupled to an information handling system is illustrated, according to one or more embodiments. As shown in FIG. 3D, HMD 310 may include sensor hub 190B. As illustrated in FIG. 3E, HMD 310 may include sensor hub 190B and may include GPU 185.

Turning now to FIG. 3F, an example of a head mounted display that includes an information handling system is illustrated, according to one or more embodiments. As shown, HMD 310 may include IHS 110. For example, HMD 310 may include one or more structures and/or one or more functionalities of those described with reference to IHS 110. In one or more embodiments, HMD 310 may be IHS 110. For example, IHS 110 may include one or more structures and/or one or more functionalities of those described with reference to HMD 310.

Turning now to FIGS. 3G-3I, examples of a head mounted display are illustrated, according to one or more embodiments. As shown in FIG. 3G, a user 350 may wear HMD 310, which may be coupled to IHS 110. As illustrated, in FIG. 3H, an angle θ may be determined with respect to HMD 310 and an axis 360. In one or more embodiments, one or more of sensors 330-334 and sensor hub 190B may determine the angle θ. For example, the angle θ may be associated with a tilt of a head of user 350. For instance, the tilt of the head of user 350 may be associated with tilting HMD 310 towards a shoulder of user 350. As shown, in FIG. 3I, an angle ϕ may be determined with respect to HMD 310 and an axis 370. In one or more embodiments, one or more of sensors 330-334 and sensor hub 190B may determine the angle ϕ. For example, the angle ϕ may be associated with a tilt of a head of user 350. For instance, the tilt of the head of user 350 may be associated with user 350 looking up and/or looking down.

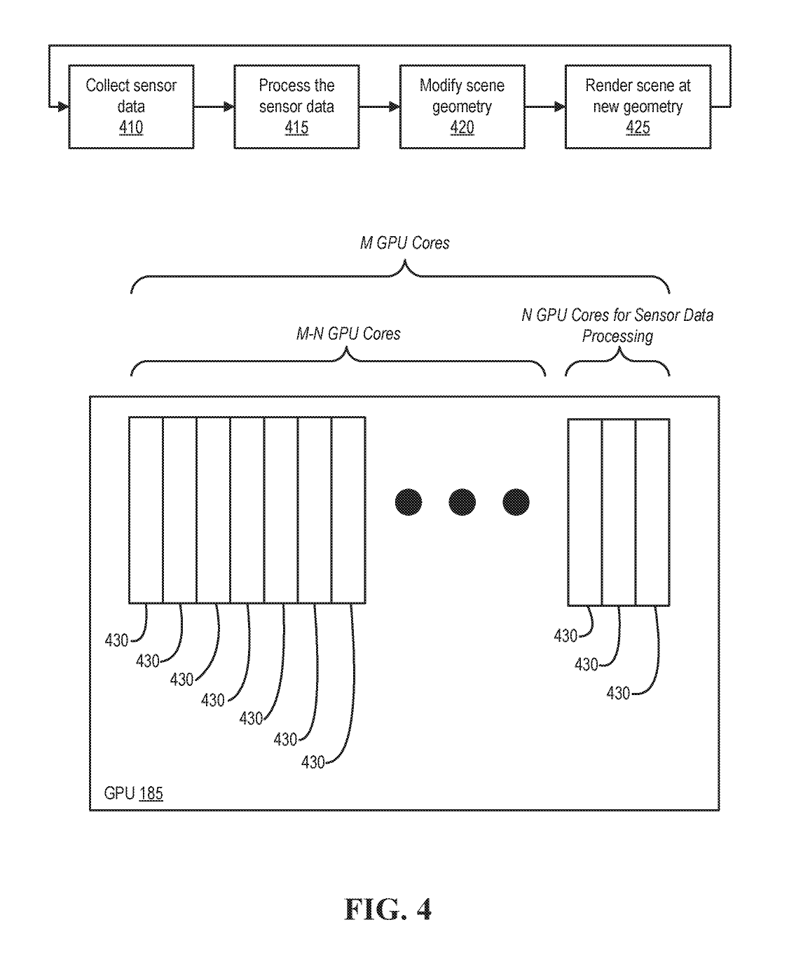

Turning now to FIG. 4, a block diagram of operating multiple GPU cores is illustrated, according to one or more embodiments. At 410, sensor data may be collected. For example, sensor hub 190B may collect sensor data from one or more of sensors 330-334 of HMD 310. At 415, the sensor data may be processed. For example, sensor hub 190B may process the sensor data from one or more of sensors 330-334 of HMD 310. In one or more embodiments, processing sensor data from one or more sensors may include receiving the sensor data in a first format and providing the data in a second format. For example, sensor hub 190B may receive data from sensor 330, via a NMEA (National Marine Electronics Association) format, and provide the data from sensor 330 via a name-value pair format.

In one or more embodiments, processing sensor data from one or more sensors may include receiving the sensor data via a first protocol and providing the data via a second protocol. In one example, sensor hub 190B may receive data from sensor 332, via an I²C protocol, and provide the data from sensor 332 via a SPI protocol. In a second example, sensor hub 190B may receive data from sensor 334, via a SPI protocol, and provide the data from sensor 334 via an I²C protocol. In another example, sensor hub 190B may receive data from sensor 330, via a SPI protocol, and provide the data from sensor 330 via an USB protocol. In one or more embodiments, processing sensor data from one or more sensors may include receiving the sensor data and processing the sensor data with one or more calibrations (e.g., one or more calibrations associated with respective one or more sensors). For example, calibration data may be stored via sensor hub data 276. For instance, processor 220 may retrieve calibration data from sensor hub data 276 and may process the sensor data in accordance with the calibration data.

At 420, one or more scene geometries may be processed. For example, multiple GPU cores 430 may modify one or more scene geometries. For instance, N of M GPU cores 430 may modify one or more scene geometries. In one or more embodiments, an application (e.g., a GPU application) may be executed by multiple GPU cores 430 that may modify one or more scene geometries based at least on the sensor data from one or more of sensors 330-334 of HMD 310. For example, the application that may be executed by multiple GPU cores 430 may include one or more OpenGL commands that may modify one or more scene geometries based at least on the sensor data from one or more of sensors 330-334 of HMD 310. At 425, a scene may be rendered at a new geometry. For example, multiple GPU cores 430 may render a scene at a new geometry. For instance, one or more of M-N cores (e.g., cores that do not process sensor data from HMD 310) may render the scene at the new geometry. In one or more embodiments, the scene at the new geometry may be provided to HMD 310. For example, HMD 310 may display the scene at the new geometry to user 350.

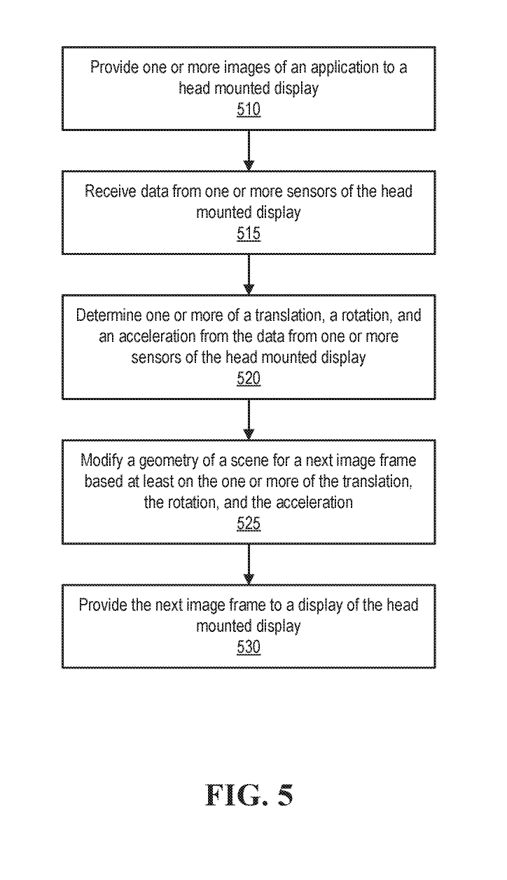

Turning now to FIG. 5, an example of a method of operating a system is illustrated, according to one or more embodiments. At 510, one or more images of an application may be provided to a head mounted display. For example, the application may be executed via processor 120. For instance, IHS 110 may execute the application and may provide the one or more images of the application to HMD 310. In one or more embodiments, the application executed via processor 120 may include one or more of an AR application, a VR application, and a MR application, among others.

At 515, data from one or more sensors of a head mounted display may be received. In one example, a sensor hub may receive the data from the one or more sensors of the head mounted display. In another example, a GPU may receive the data from the one or more sensors of the head mounted display. For instance, GPU 185 may receive the data from the one or more sensors of the head mounted display. In one or more embodiments, GPU 185 may receive the data from the one or more sensors of the head mounted display without the data being communicated via at least one central processing unit of an information handling system. For example, GPU 185 may receive the data from the one or more sensors of the head mounted display without the data being communicated via processor 120 of IHS 110. In one or more embodiments, a GPU may receive the data from the one or more sensors of the head mounted display via a sensor hub. For example, GPU 185 may receive the data from the sensor of the head mounted display via sensor hub 190B. In one or more embodiments, the data from the one or more sensors of the head mounted display may be or may include processed data. For example, the sensor hub may process the data from the one or more sensors of the head mounted display. In one or more embodiments, receiving the data from the one or more sensors of the head mounted display may include receiving the processed data from the sensor hub. For instance, GPU 185 may receive the processed data from sensor hub 190B. For instance, the sensor hub may receive raw sensor data from the one or more sensors of the head mounted display, may process the raw sensor data, and/or may provide the data (e.g., processed data) from the one or more sensors of the head mounted display to the GPU.

At 520, one or more of a translation, a rotation, and an acceleration may be determined from the data from the one or more sensors of the head mounted display. For example, GPU 185 may determine the one or more of the translation, the rotation, and the acceleration from the data from the one or more sensors of the head mounted display. For instance, an application (e.g., a GPU application) executing on one or more of multiple cores of GPU 185 may determine the one or more of the translation, the rotation, and the acceleration from the data from the one or more sensors of the head mounted display. At 525, a geometry of a scene for a next image frame may be modified based at least on the one or more of the translation, the rotation, and the acceleration. For example, GPU 185 may modify the geometry of the scene for the next image frame based at least on the one or more of the translation, the rotation, and the acceleration, among others. For instance, an application executing on one or more of multiple cores of GPU 185 may modify the geometry of the scene for the next image frame based at least on the one or more of the translation, the rotation, and the acceleration, among others.

In one or more embodiments, modifying the geometry of the scene for the next image frame based at least on the one or more of the translation, the rotation, and the acceleration may include at least a first graphics processing unit core modifying the geometry of the scene for the next image frame based at least on the one or more of the translation, the rotation, and the acceleration. In one example, at least the first graphics processing unit core modifying the geometry of the scene for the next image frame based at least on the one or more of the translation, the rotation, and the acceleration may include the first graphics processing unit core modifying the geometry of the scene for the next image frame based at least on the one or more of the translation, the rotation, and the acceleration. In another example, at least the first graphics processing unit core modifying the geometry of the scene for the next image frame based at least on the one or more of the translation, the rotation, and the acceleration may include first multiple graphics processing unit cores modifying the geometry of the scene for the next image frame based at least on the one or more of the translation, the rotation, and the acceleration. For instance, the first multiple graphics processing unit cores may execute the application that may modify the geometry of the scene for the next image frame based at least on the one or more of the translation, the rotation, and the acceleration, and second multiple graphics processing unit cores, different from the first multiple graphics processing unit cores, may execute instructions, other than the application. In one or more embodiments, the first multiple graphics processing unit cores may execute the application in parallel with the second multiple graphics processing unit cores executing the instructions, other than the application.

At 530, the next image frame may be provided to a display of the head mounted device. For example, GPU 185 may provide the next image frame to display 320 of HMD 310. In one or more embodiments, providing the next image frame to the display of the head mounted device may include at least a second graphics processing unit core, different from the first graphics processing unit core, providing the next image frame to the display of the head mounted device.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. An information handling system, comprising:
at least one processor;
a graphics processing unit; and
a memory medium, coupled to the at least one processor and coupled to the graphics processing unit;
wherein the memory medium includes processor instructions, which when executed by the at least one processor, cause the information handling system to:
provide images of an application to a head mounted display; and
wherein the memory medium includes graphics processing unit instructions, which when executed by the graphics processing unit, cause the graphics processing unit to:
receive data from one or more sensors of the head mounted display without the data being communicated via the at least one processor;
determine one or more of a translation, a rotation, and an acceleration from the data from the one or more sensors of the head mounted display;
modify a geometry of a scene for a next image frame based at least on the one or more of the translation, the rotation, and the acceleration; and
provide the next image frame to a display of the head mounted device.

2. The information handling system of claim 1,
wherein, when the graphics processing unit modifies the geometry of the scene for the next image frame based at least on the one or more of the translation, the rotation, and the acceleration, a first graphics processing unit core of the graphics processing unit modifies the geometry of the scene for the next image frame based at least on the one or more of the translation, the rotation, and the acceleration; and
wherein, when the graphics processing unit provides the next image frame to the display of the head mounted device, a second graphics processing unit core of the graphics processing unit, different from the first graphics processing unit core, provides the next image frame to the display of the head mounted device.

3. The information handling system of claim 1,
wherein the graphics processing unit includes a first plurality of graphics processing unit cores; and
wherein, to modify the geometry of the scene for the next image frame based at least on the one or more of the translation, the rotation, and the acceleration, the memory medium further comprises graphics processing unit instructions, which when executed by the graphics processing unit, further cause the graphics processing unit to utilize the first plurality of graphics processing unit cores of the graphics processing unit to execute a graphics processing unit application that modifies the geometry of the scene for the next image frame based at least on the one or more of the translation, the rotation, and the acceleration.

4. The information handling system of claim 3,
wherein the graphics processing unit includes a second plurality of graphics processing unit cores, different from the first plurality of graphics processing unit cores; and
wherein the memory medium further comprises graphics processing unit instructions, which when executed by the graphics processing unit, further cause the graphics processing unit to:
utilize the second plurality of graphics processing unit cores of the graphics processing unit to execute instructions different from the graphics processing unit application that modifies the geometry of the scene for the next image frame.

5. The information handling system of claim 1, wherein, to receive the data from the one or more sensors of the head mounted display, the memory medium further comprises graphics processing unit instructions, which when executed by the graphics processing unit, further cause the graphics processing unit to receive the data from the one or more sensors of the head mounted display via a sensor hub that is coupled to the graphics processing unit and the one or more sensors of the head mounted display.

6. The information handling system of claim 5, wherein the sensor hub is configured to:
receive raw sensor data from the one or more sensors of the head mounted display;
process the raw sensor data from the one or more sensors of the head mounted display to produce the data from the one or more sensors of the head mounted display; and
provide the data from the one or more sensors of the head mounted display to the graphics processing unit.

7. The information handling system of claim 5, wherein the head mounted display includes the sensor hub.

8. A method, comprising:
a graphics processing unit receiving data from one or more sensors of a head mounted display without the data being communicated via at least one central processing unit of an information handling system;
the graphics processing unit determining one or more of a translation, a rotation, and an acceleration from the data from the one or more sensors of the head mounted display;
the graphics processing unit modifying a geometry of a scene for a next image frame based at least on the one or more of the translation, the rotation, and the acceleration; and
the graphics processing unit providing the next image frame to a display of the head mounted device.

9. The method of claim 8,
wherein the graphics processing unit modifying the geometry of the scene for the next image frame based at least on the one or more of the translation, the rotation, and the acceleration includes a first graphics processing unit core modifying the geometry of the scene for the next image frame based at least on the one or more of the translation, the rotation, and the acceleration; and
wherein the graphics processing unit providing the next image frame to the display of the head mounted device includes a second graphics processing unit core, different from the first graphics processing unit core, providing the next image frame to the display of the head mounted device.

10. The method of claim 8, wherein the graphics processing unit modifying the geometry of the scene for the next image frame based at least on the one or more of the translation, the rotation, and the acceleration includes a first plurality of graphics processing unit cores of the graphics processing unit executing a graphics processing unit application that modifies the geometry of the scene for the next image frame based at least on the one or more of the translation, the rotation, and the acceleration.

11. The method of claim 10, further comprising:
a second plurality of graphics processing unit cores of the graphics processing unit, different from the first plurality of graphics processing unit cores, executing instructions different from the graphics processing unit application that modifies the geometry of the scene for the next image frame.

12. The method of claim 8, wherein the graphics processing unit receiving the data from the one or more sensors of the head mounted display includes the graphics processing unit receiving the data from the one or more sensors of the head mounted display via a sensor hub that is coupled to the graphics processing unit and the one or more sensors of the head mounted display.

13. The method of claim 12, further comprising:
the sensor hub receiving raw sensor data from the one or more sensors of the head mounted display;
the sensor hub processing the raw sensor data from the one or more sensors of the head mounted display to produce the data from the one or more sensors of the head mounted display; and
the sensor hub providing the data from the one or more sensors of the head mounted display to the graphics processing unit.

14. The method of claim 12, wherein the head mounted display includes the sensor hub.

15. A graphics processing unit, comprising:
multiple graphics processing unit cores;
wherein the graphics processing unit is configured to be coupled to a sensor hub; and
wherein the graphics processing unit executes first graphics processing unit instructions, which cause the graphics processing unit to:
receive, via the sensor hub, data from one or more sensors of the head mounted display without the data being communicated via at least one central processing unit of an information handling system, wherein the sensor hub is coupled to the graphics processing unit and the one or more sensors of the head mounted display;
determine one or more of a translation, a rotation, and an acceleration from the data from the one or more sensors of the head mounted display;
modify a geometry of a scene for a next image frame based at least on the one or more of the translation, the rotation, and the acceleration; and
provide the next image frame to a display of the head mounted device.

16. The graphics processing unit of claim 15,
wherein, when the graphics processing unit modifies the geometry of the scene for the next image frame based at least on the one or more of the translation, the rotation, and the acceleration, a first graphics processing unit core of the multiple graphics processing unit cores modifies the geometry of the scene for the next image frame based at least on the one or more of the translation, the rotation, and the acceleration; and
wherein, when the graphics processing unit provides the next image frame to the display of the head mounted device, a second graphics processing unit core of the multiple graphics processing unit cores, different from the first graphics processing unit core, provides the next image frame to the display of the head mounted device.

17. The graphics processing unit of claim 15,
wherein the multiple graphics processing unit cores include a first plurality of graphics processing unit cores; and
wherein, to modify the geometry of the scene for the next image frame based at least on the one or more of the translation, the rotation, and the acceleration, the graphics processing unit instructions, which when executed by the graphics processing unit, further cause the graphics processing unit to utilize the first plurality of graphics processing unit cores of the graphics processing unit to execute a graphics processing unit application that modifies the geometry of the scene for the next image frame based at least on the one or more of the translation, the rotation, and the acceleration.

18. The graphics processing unit of claim 17,
wherein the multiple graphics processing unit cores include a second plurality of graphics processing unit cores, different from the first plurality of graphics processing unit cores; and
wherein the graphics processing unit instructions, which when executed by the graphics processing unit, further cause the graphics processing unit to:
utilize the second plurality of graphics processing unit cores of the graphics processing unit to execute instructions different from the graphics processing unit application that modifies the geometry of the scene for the next image frame.

19. (canceled)

20. The graphics processing unit of claim 15, wherein the head mounted display includes the sensor hub.

21. The graphics processing unit of claim 15, wherein the sensor hub includes a processor.
